(19) United States
(12) Patent Application Publication
(10) Pub. No.: US 2002/0152854 A1
(43) Pub. Date: Oct. 24, 2002

(54) Electrical Connector housing cutting apparatus

(76) Inventors: R. Douglas Sheaffer, Mechanicsburg, PA (US); Glenn J. Pontius, New Cumberland, PA (US); W. John Ravert JR., Harrisburg, PA (US); Gary A. Hitz, New Cumberland, PA (US)

Correspondence Address: PERMAN & GREEN, 425 POST ROAD, FAIRFIELD, CT, 06824, US

(21) Appl. No.: 09/841,254

(22) Filed: Apr. 24, 2001

(51) Int. Cl. B26D 1/18

(52) U.S. Cl. 83/13; 83/466.1; 83/485

(57) ABSTRACT

An electrical connector housing cutting apparatus comprising a guide and a rotating cutting member. The guide is adapted to slidably support an electrical connector housing along a linear movement path. The rotating cutting member is movable into and out of the movement path. The cutting member has an axis of rotation generally parallel to a direction of movement of the electrical connector housing along the movement path.

### BACKGROUND OF THE INVENTION

1. Field of the Invention

The present invention relates to a cutting apparatus and, more particularly, to a cutting apparatus for cutting a housing of an electrical connector such as a receptacle connector.

2. Brief Description of Prior Developments

U.S. Pat. No. 5,078,034 discloses a connector housing separation mechanism. The mechanism has a horizontally reciprocating cutting bar. U.S. Pat. No. 4,830,554 discloses a routing apparatus for cutting printed circuit boards. U.S. Pat. No. 5,590,576 discloses an apparatus with a vertical severing knife.

Some electrical connectors, such as DUBOX™ and MINITEK™ electrical connectors sold by FCI USA, Inc. of Etters, Pa. are manufactured with a molded plastic housing piece which has apertures for receiving electrical contacts. Sometimes it is desirable to mold a plastic housing piece with a first relatively long length and, if smaller length connectors are desired, to cut the first relatively long length plastic housing piece into a plurality of second relatively smaller length plastic housing pieces. The cut is located between adjacent contact receiving apertures of the housing piece. There is a desire to cut molded plastic housing pieces more efficiently, with increased speed, less waste, and assistance of a computer controller. This can reduce the costs associated with molded plastic housing pieces for electrical connectors such that separate housing molds are not required for different length connectors, and the speed for cutting of housing pieces can be accelerated.

### SUMMARY OF THE INVENTION

In accordance with one embodiment of the present invention, an electrical connector housing cutting apparatus is provided comprising a guide and a rotating cutting member. The guide is adapted to slidably support an electrical connector housing along a linear movement path. The rotating cutting member is movable into and out of the movement path. The cutting member has an axis of rotation generally parallel to a direction of movement of the electrical connector housing along the movement path.

In accordance with another embodiment of the present invention, an electrical connector housing cutting apparatus is provided comprising a cutter, a mover, a diverter and a computer controller. The cutter is for cutting an electrical connector housing into multiple pieces. The mover is for moving the electrical connector housing relative to the cutter. The diverter is located after the cutter in a path of the electrical connector and is movable between at least two positions for allowing a cut piece to move to one of at least two predetermined locations. The computer controller is connected to the mover and the diverter for moving the diverter based, at least partially, upon a next intended length of movement of the electrical connector housing by the mover.

In accordance with another embodiment of the present invention, an electrical connector housing cutting apparatus is provided comprising a frame, a mover, a cutter, a diverter and a computer controller. The frame forms a housing movement path for moving electrical connector housings therealong. The mover is for moving the electrical connector housing along the path in at least two predetermined different lengths of movement. The cutter comprises a rotatable cutting wheel. The cutting wheel has an axis of rotation parallel to the path, and the cutting wheel is movable in a cutting path into and out of the housing movement path. The diverter is located in the housing movement path after the cutting path of the cutting wheel. The diverter is movable between at least two positions for allowing cut pieces of the housing to move to at least two different locations based upon the position of the diverter. The computer controller is connected to the mover, the diverter and the cutter. The controller is adapted to control the mover, the diverter and the cutter to cut the housings into pieces having a predetermined length and separate the pieces from other cut pieces which do not have the predetermined length.

In accordance with one method of the present invention, a method of cutting an electrical connector housing into multiple pieces is provided comprising steps of moving the housing along a housing movement path to a cutting position; moving a rotating cutting wheel across the movement path at the cutting position, the wheel rotating in an axis of rotation generally parallel to the movement path; and automatically separating an undesired length cut housing piece from desired length cut housing pieces as the pieces move away from the cutting position.

### BRIEF DESCRIPTION OF THE DRAWINGS

The foregoing aspects and other features of the present invention are explained in the following description, taken in connection with the accompanying drawings, wherein:

FIG. 1 is a perspective view of an apparatus incorporating features of the present invention with its cover in an exploded position;

FIG. 2 is a partial perspective view of portions of the apparatus shown in FIG. 2;

FIG. 3A is a partial cross-sectional view of a housing piece in the housing piece guide and connected to the mover;

FIG. 3B is a partial cross-sectional view of the housing piece guide, the housing piece and the clamp at the cutting area;

FIG. 3C is a top plan view of the end of the housing piece guide at the cutting area;

FIG. 3D is a partial top plan view of the housing piece located at the cutting area;

FIG. 4 is an exploded perspective view of portions of the cutter of the apparatus;

FIG. 5A is a perspective view of the clamp of the apparatus shown in FIGS. 1 and 2;

FIG. 5B is a partial top plan view of the clamp, the cutting wheel and the housing piece guide at the cutting area;

FIG. 6 is a perspective view of the mover of the apparatus shown in FIGS. 1 and 2;

FIG. 7 is a partial perspective view of the diverter on the frame of the apparatus shown in FIGS. 1 and 2;

FIG. 7A is an exploded perspective view of the diverter shown in FIG. 7;

FIG. 8 is a schematic diagram of the control system for the apparatus shown in FIG. 1;

FIG. 9 is a simplified method flow chart of one method of the present invention; and

FIG. 10 is a schematic diagram illustrating how a relatively long housing piece can be cut into smaller desired length housing pieces and scrap pieces.

### DETAILED DESCRIPTION OF THE PREFERRED EMBODIMENT

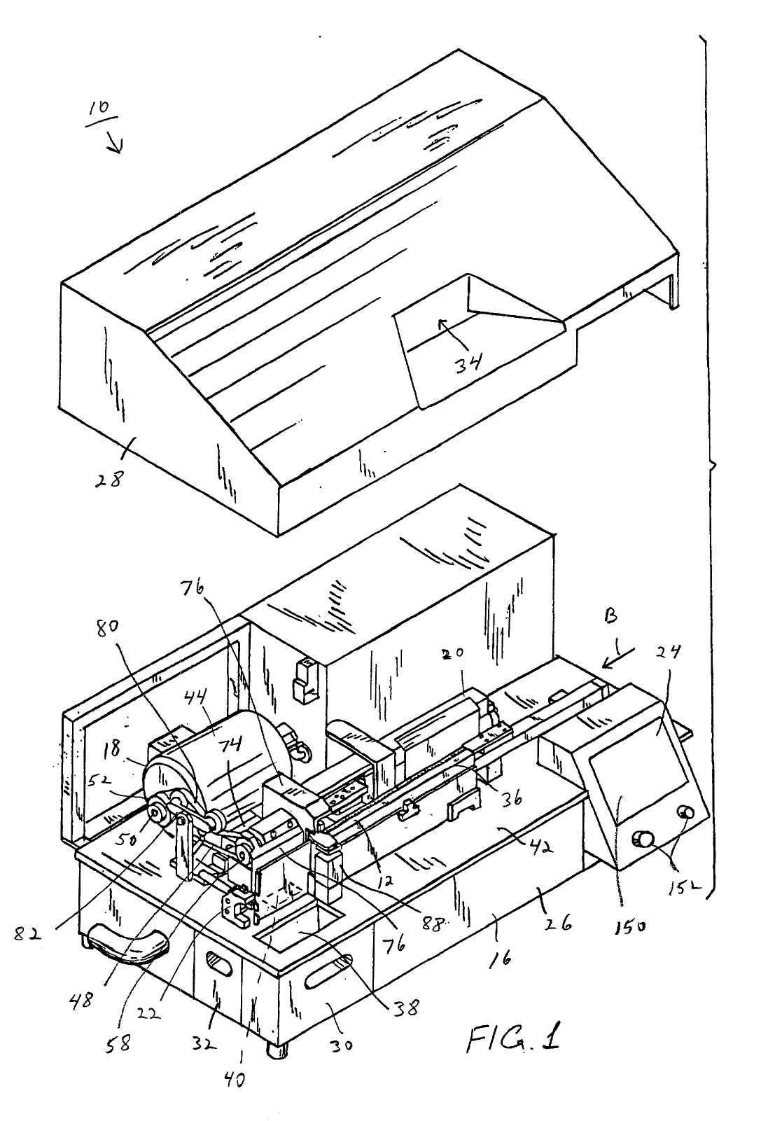

Referring to FIG. 1, there is shown an exploded perspective view of an apparatus 10 incorporating features of the present invention. Although the present invention will be described with reference to the single embodiment shown in the drawings, it should be understood that the present invention can be embodied in many alternate forms of embodiments. In addition, any suitable size, shape or type of elements or materials could be used.

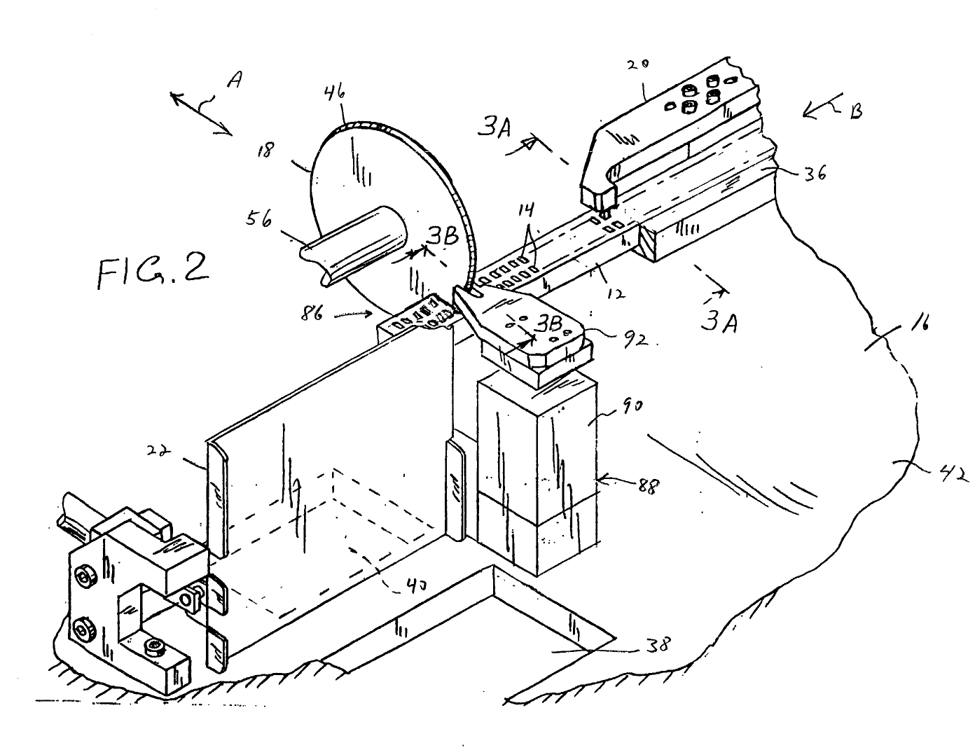

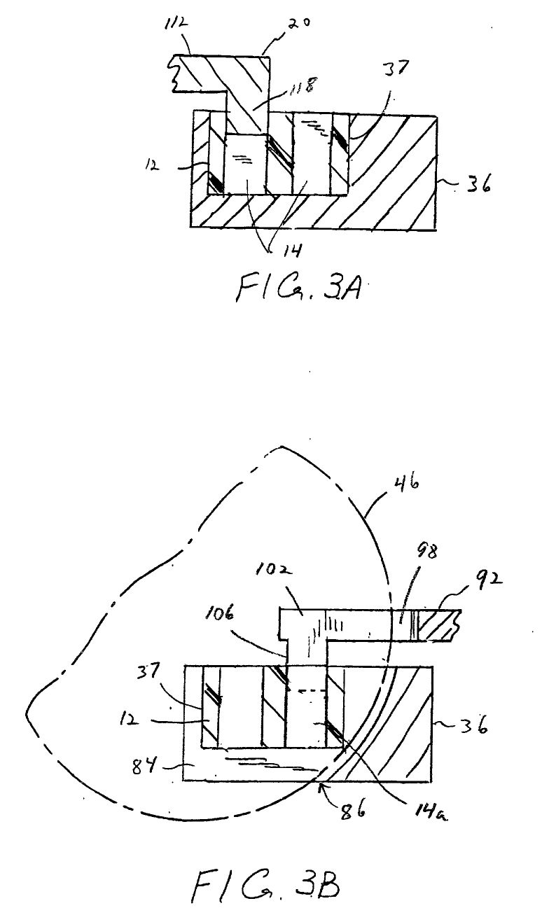

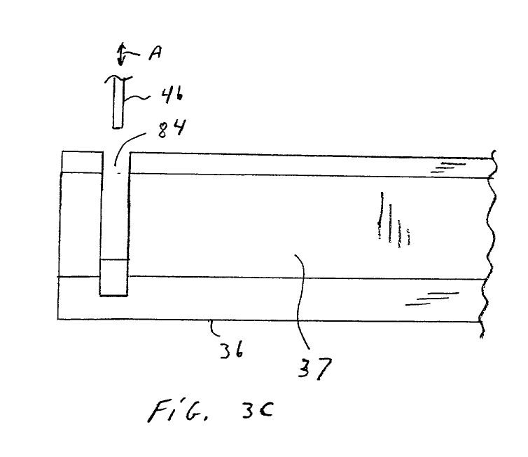

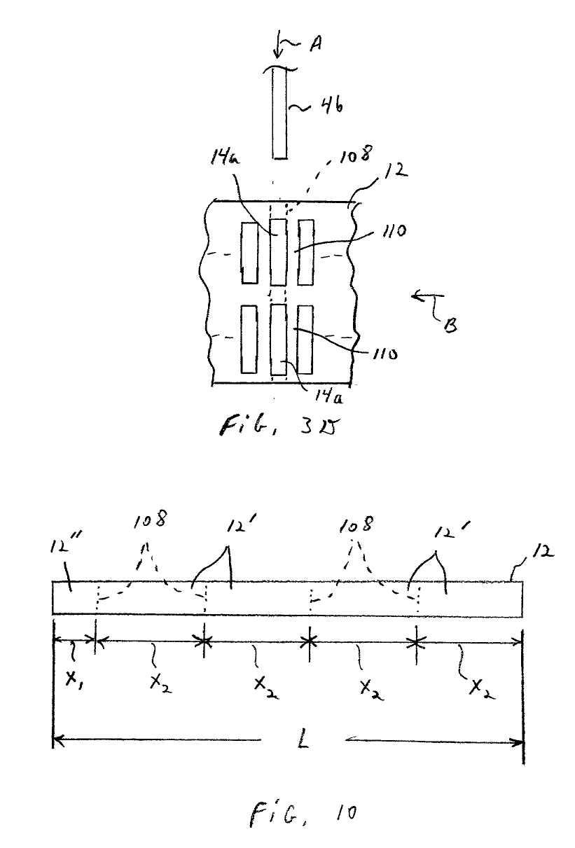

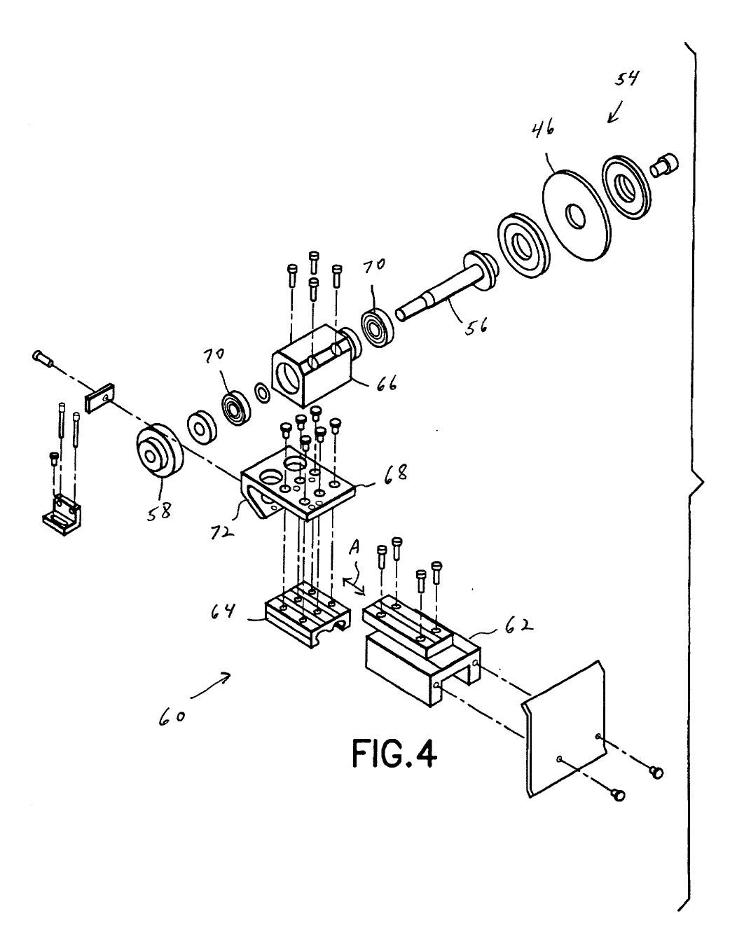

The apparatus 10 is for cutting housing pieces 12 which are used in electrical connectors. The housing pieces 12 are preferably cut by the apparatus 10 before electrical contacts are inserted in the housing piece. However, in an alternate embodiment the apparatus 10 could be used to cut housing pieces having electrical contacts already attached to the housing pieces. The housing pieces are preferably comprised of molded plastic. However, the housing pieces could be comprised of any suitable material(s) and/or could be formed from any suitable type of manufacturing process. As seen in FIGS. 2 and 3A, the housing piece 12 has apertures 14 for receiving the electrical contacts therein and for allowing the contacts to engage a mating connector (not shown). In the embodiment shown the apertures are arranged in two rows along the length of the housing piece 12. However, the apertures 14 could be arranged in any suitable pattern or array.

The apparatus 10 generally comprises a frame 16, a cutter 18, a mover 20, a diverter 22, and a computer controller 24. However, in an alternate embodiments the apparatus 10 could comprise additional or alternative components. The frame 16 generally comprises a base 26, a cover 28, and two drawers 30, 32.

The cover 28 might be transparent, or a portion of the cover could be transparent. The cover 28 preferably has an opening 34 to allow a user to insert the housing pieces 12 into a feeding guide 36 of the frame 16. However, the opening 34 might not be provided, or any suitable mechanism or system could be used to load the housing pieces 12 into the feeding guide 36. The cover 28 and the size of the opening 34 protect the user by preventing the user from getting his hand close to the cutter 18 during cutting.

The drawers 30, 32 are removably connected to the base 26. The base 26 has holes 38, 40 through its main top support surface 42 that are aligned with the drawers 30, 32. Thus, the holes 38, 40 provide passages into the drawers 30, 32 for the cut housing pieces. In an alternate embodiment any suitably type of storage areas could be provided and any suitable type of access to the storage areas could be provided.

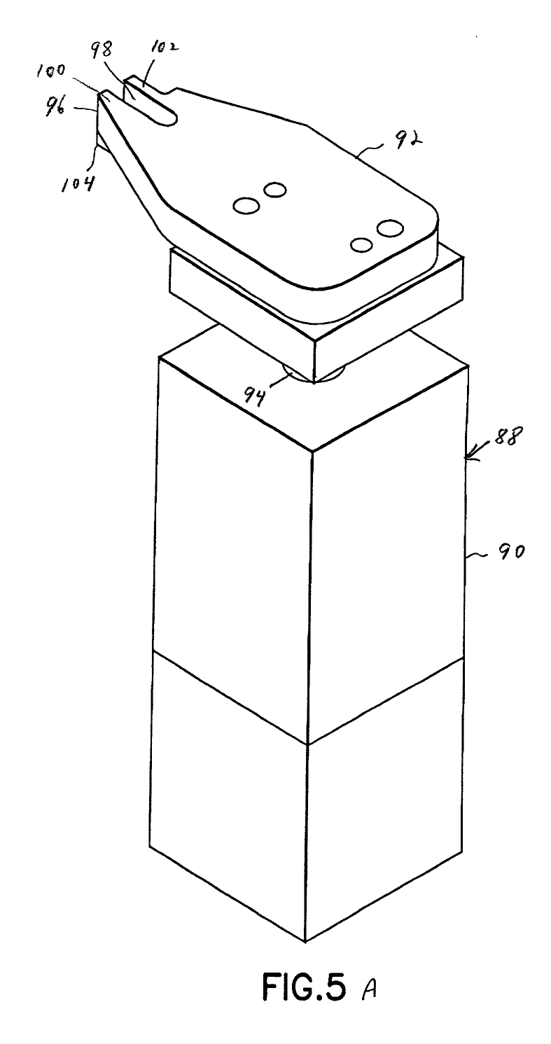

Referring also to FIGS. 2 and 4, the cutter 18 generally comprises a motor 44 (see FIG. 1), a cutting member 46, and a transmission 48 (see FIG. 1) connecting the motor to the cutting member. The motor 44 is an electric motor having an output shaft 50 and an output pulley 52 on the output shaft 50. However, in alternate embodiments any suitable motor and motor output could be provided. The motor 44 has an outer housing which is fixedly connected to the top surface 42 of the frame 16 at a stationary location. However, the motor could be movably mounted to the frame.

The cutting member 46 is preferably a rotating cutting wheel. However, features of the present invention could be used with other types of cutting members. The cutting wheel 46 is part of a cutting wheel shaft assembly 54 which includes a shaft 56 and an input pulley 58 connected to the shaft 56. The shaft assembly 54 is connected to the base 26 of the frame 16 by a mount 60.

The mount 60 generally comprises a base 62, a slide 64, and a shaft block 66. The base 62 is stationarily connected to the top surface 42 of the frame's base 26. The slide 64 is slidably mounted to the base 62 for back and forth motion as indicated by arrow A in FIG. 4. The connection plate 68 fixedly connects the shaft block 66 to the slide 64. The shaft 56 is rotatably supported in the shaft block 66 by bearings 70. However, in alternate embodiments any suitable shaft assembly mount could be provided. The mount 60 allows the cutting wheel shaft assembly 54 and the cutting wheel 46 to move forward and backward as indicated by arrow A in FIG. 2 while the cutting wheel 46 is rotated.

The connection plate 68 has a rear end 72 which is connected to a drive 74 (see FIG. 1). The drive 74 is preferably a linear drive, such is an air cylinder with a piston. However, any suitable drive could be provided. The drive 74 is adapted to move the connection plate 68 forward and backward as indicated by arrow A with the slide 64 linearly moving on the base 62. The shaft block 66 and the shaft assembly 54 move with the slide 64. This allows the cutting wheel 46 to move into and out of a cutting area. The mount 60 also has a cutting wheel cover 76 over the wheel 46 and a shield 78 at a front of the mount.

The transmission 48 generally comprises a transmission member 80 and a tensioner 82. However, in alternate embodiments any suitable type of transmission could be provided. Alternatively, the motor could be directly connected to the cutting wheel or the cutting wheel shaft assembly. In the embodiment shown, the transmission member 80 is a belt. However, any suitable transmission member could be provided. The tensioner 82 has two rollers on a rotatable arm. The two rollers each contact opposite sides of the belt 80. The belt 80 extends between the two pulleys 52, 58 of the motor and cutting wheel shaft assembly. The rotatable arm is preferably spring biased to keep the belt 80 taut between the two pulleys 52, 58. With this embodiment the transmission 48 forms a variable distance transmission between the motor and the rotating cutting wheel to compensate for the varying distance between the motor and the cutting wheel as the cutting wheel shaft assembly 54 is moved as indicated by arrow A. In an alternate embodiment the guide 36 might move towards the cutting wheel 46.

As noted above, the frame 16 includes a feeding guide 36. As seen best in FIG. 3A, the guide 36 has a slot 37 which is sized and shaped to slidably support one or more of the housing pieces 12 therein such that the housing piece 12 can slide laterally in direction B (see FIGS. 1 and 2) along its longitudinal axis. The guide 36 is adapted to support the housing piece 12 with its contact receiving apertures 14 vertically orientated such that openings into the apertures 14 are located on top. However, any suitable guide could be provided and, the openings into the apertures might not be located on top. As seen in FIGS. 3B and 3C, the end of the guide 36 proximate the cutting wheel 46 preferably has a slot 84 which is transverse to the slot 37 and extends into the top, bottom and rear sides of the guide 36 at the cutting area 86. In an alternate embodiment the guide 36 might end at the start of the cutting area 86 or, any suitable configuration to accommodate movement of the cutting wheel 46 into the cutting area for cutting the housing piece 12 could be provided.

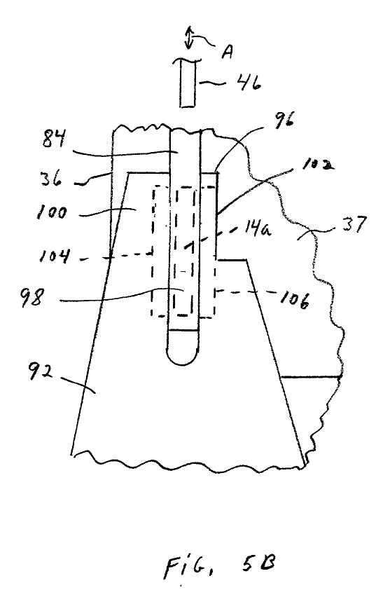

Referring now to FIGS. 1, 2, 5A, and 5B, also located at the cutting area 86 is a clamp 88. However, in an alternate embodiment the clamp might not be provided, or any suitable type of clamp could be provided. The clamp 88 includes a drive 90 and a clamping member 92 connected to the drive. The drive 90 has a shaft 94 which is vertically movable between an up position and a down position. The drive 90 can be any suitable type of drive, but is preferably air cylinder operated. The clamp member 92 is attached to the top of the shaft 94. Thus, the clamp member 92 is moved up and down when the shaft 94 is moved up and down. The clamp member 92 has an end 96 which has a slot 98. The end 96, thus, forms two arms 100, 102. Each arm 100, 102 has a finger 104, 106 which projects in a downward direction from the bottom side of the arms. However, in alternate embodiments, the clamp member could have any suitable shape or configuration.

The end 96 is located over the guide 36 at the cutting area 86. More specifically, the slot 98 is aligned with the cutting wheel 46 such that, when the cutting wheel 46 is moved forward, it can project into the slot 98 without contacting the clamping member 92. When the clamping member 92 is in an up position, the bottoms of the fingers 104, 106 are located above the lateral path of the housing piece 12 in the slot 37 of the guide 36. When the clamping member 92 is moved to its down position, the fingers 104, 106 can project into the contact receiving apertures 14 of the housing piece 12. The fingers 104, 106 are suitably spaced relative to each other such that they can be placed in two apertures 14 with an aperture 14a therebetween; the aperture 14a being located aligned under the slot 98. The bottom sides 107, 109 of the arms 100, 102 can press against the top side 13 of the housing piece 12 to temporarily stationarily hold the housing piece against the guide 36. The fingers 104, 106 can function to precisely position the housing piece relative to the path of the cutting wheel 46.

As seen in FIG. 3D, the cutting wheel 46 can cut across the housing piece 12 in direction A, which is generally transverse to the path of the housing piece 12 in direction B. The location of the cut 108 is preferably along and through the apertures 14a. By cutting through the apertures 14a, the housing piece 12 can be manufactured with the walls 110 between the apertures having a very small thickness without cutting into the walls 110.

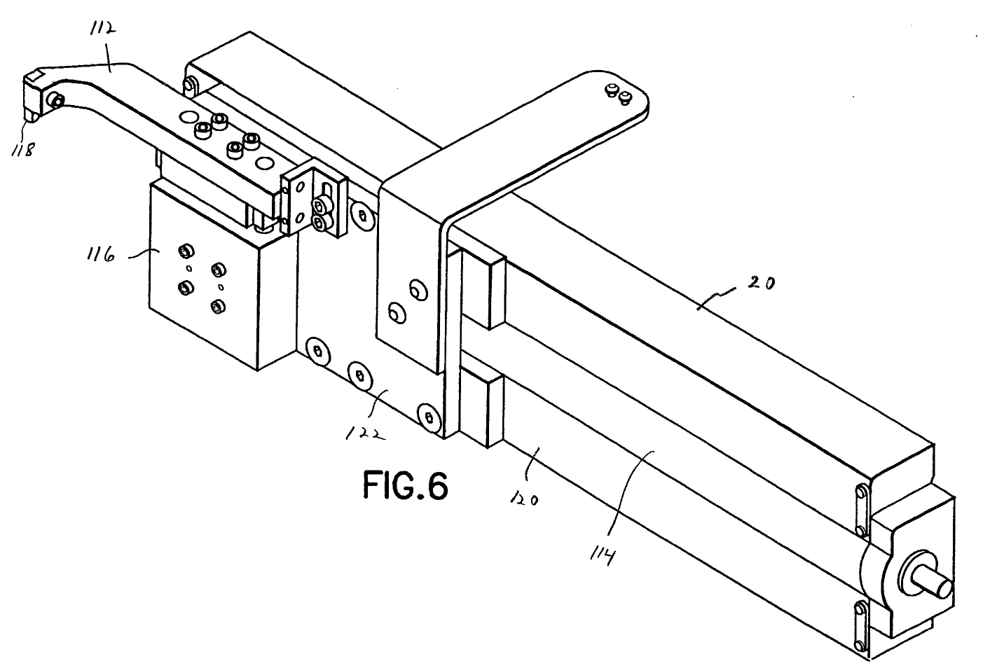

Referring now to FIGS. 1, 2, 3A and 6, the mover 20 generally comprises an arm 112, a first drive 114 and a second drive 116. In an alternate embodiment the second drive 116 may be omitted, such as when the arm 112 is intended to be vertically moved only manually by a user. However, any suitable mover could be provided. The arm 112 comprises a finger 118. The finger 118 projects in a downward direction. The finger 118 is suitably sized and shaped to be located in one of the contact receiving apertures 14 of the housing piece 12.

The second drive 116 is a vertical drive, such is an air cylinder, adapted to move the arm 112 up and down. Thus, the second drive 116 can move the finger 118 between an up position and a down position. In the down position, as shown in FIG. 3A, the finger 118 can project into the slot 37 and, more particularly, can project into one of the apertures 14. The arm 112 could contact the housing piece 12 in any suitable fashion. However, it has been found that placing the finger 118 in one of apertures 14 can provide a more precise and accurate movement or positioning of the housing piece 12 for cutting precisely at the apertures 14a.

The second drive 116 is connected to the first drive 114. The first drive 114 in this embodiment is a linear horizontal drive such as a linear ball screw PLC controlled drive, adapted to move the second drive 116 and the arm 112 parallel to the path of movement of the housing piece 12 in the slot 37 of the guide 36. In the embodiment shown the first drive 114 is fixedly mounted to the top surface 42 of the base 26 of the frame 16. The first drive 114 has a first section 120 mounted to the top surface 42 at a stationarily location and a second section 122 which is movable along the first section 120. The second drive is mounted to the second section 122.

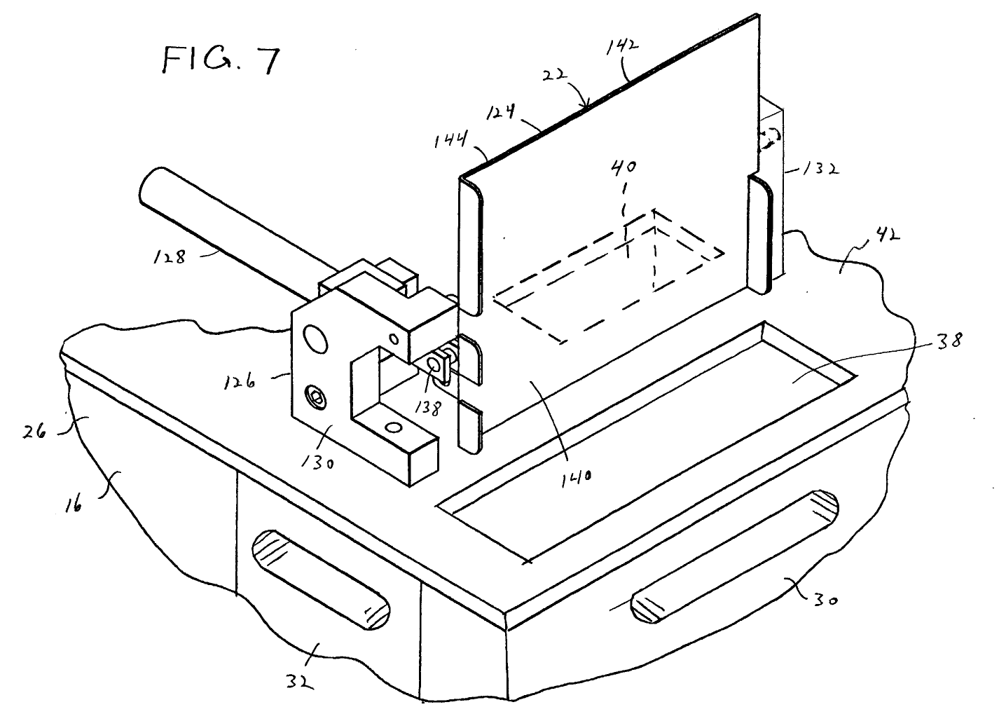

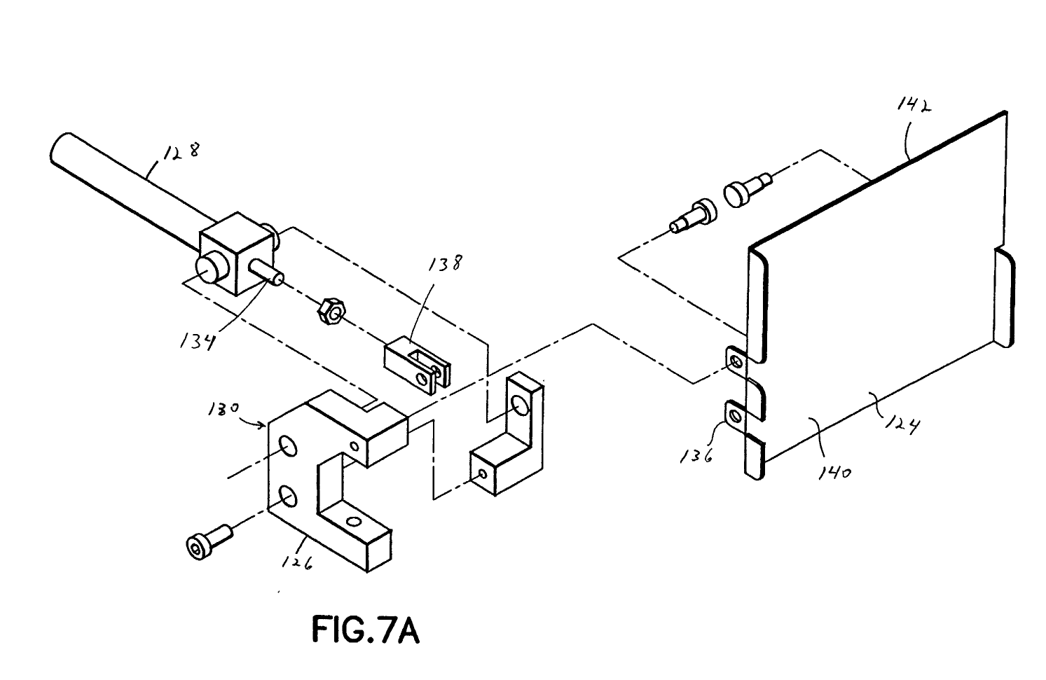

Referring now to FIGS. 1, 2, 7 and 7A, the diverter 22 generally comprises a plate section 124, a mount 126, and a drive 128. The mount 126 is connected to the top surface 42 of the base 26 of the frame 16. The mount 126 has two side sections 130, 132. The plate section 124 is pivotably mounted between the two side section 130, 132 such that the top and bottom of the plate section 124 can move forward and backward. However, any suitable mount or movable connection of the plate section could be provided.

The drive 128 is connected to the left side section 130. In this embodiment the drive 128 is a linear drive with a piston member 134 which can be extended forward and retracted rearward. The piston member 134 is connected to a mounting flange 136 of the plate section 124 by a swivel connector 138. However, any suitable type of connection and any suitable type of drive could be provided.

The plate section 124 has two housing piece contact surfaces 140, 142 on opposite front and rear sides of the plate section. However, the plate section could have any suitable shape. The plate section 124 is generally located between the two holes 38, 40 through the top surface 42 of the base 26 of the frame 16. The top end 144 of the plate section 124 is located past the left side end of the guide 36, and past the cutting area 86 and the path of the cutting wheel 46. The top end 144 extends above the top of the guide 36.

When the top end 144 is in a forward position, the top end 144 is located in front of a plane of the slot 37. Thus, the housing piece can be pushed behind the surface 142 and, when a piece of the housing piece 12 is cut off by the cutting wheel 46, the cut off piece can slide along the surface 142 through the hole 40 and into the drawer 32.

When the top end 144 of the plate section 124 is located in a rearward position, the top end 144 is located behind the plane of the slot 37. Thus, the housing piece can be pushed in front of the surface 140 and, when a piece of the housing piece 12 is cut off by the cutting wheel 46, the cut off piece can slide along the surface 140 through the hole 38 and into the drawer 30. In alternate embodiments, any suitable type of diverter could be provided. Alternatively, a diverter might not be provided, such as when the different length cut housing pieces are separated at a later time, or when the cut housing pieces all have the same length.

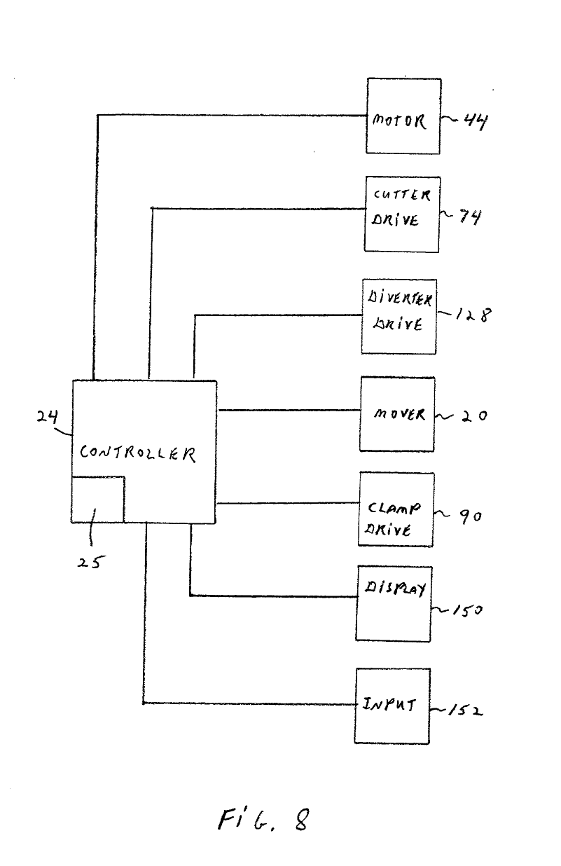

Referring now to FIG. 8, a schematic view of some of the components of the apparatus 10 is shown. The controller 24 is operably connected to the motor 44, the cutter drive 74, the diverter drive 128, the mover 20, the clamp drive 90, a display 150 and an user input device 152. Any suitable types of display and input could be provided. The controller 24 is adapted to control operation of these components based upon its programming, information input by a user into the input device 152, and information from sensors (not shown) regarding the positions of select members of the apparatus.

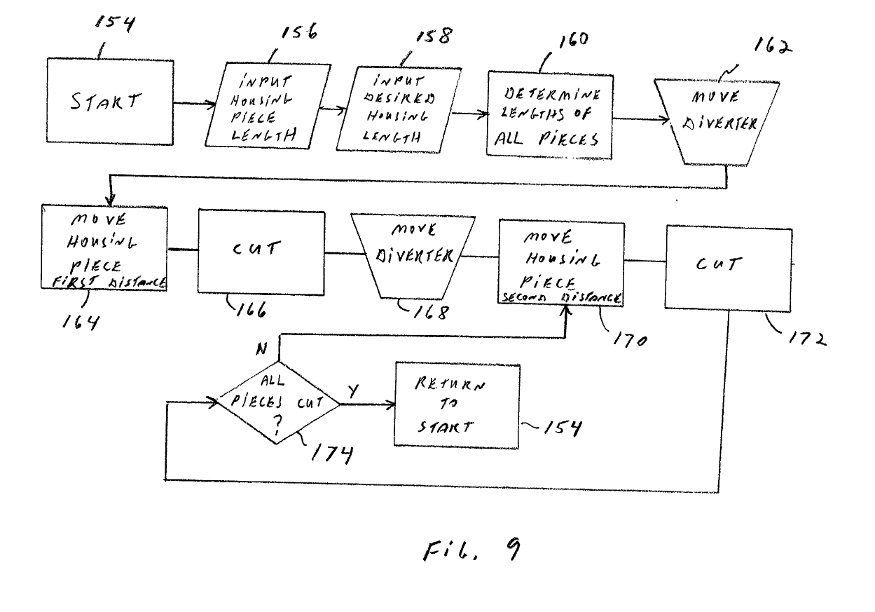

Referring also to FIG. 9, a simplified flow chart of some of the steps of one method of operation of the apparatus 10 is shown. At start 154 the user would insert the uncut relatively long housing piece 12 into the guide 36 and insert the finger 118 of the mover 20 into the last aperture 14 on the right side of the housing piece 12. With this connection, and a position sensor in the mover 20, the controller 24 can now determine the precise location of the housing piece 12 relative to the cutting area 86.

The user inputs the length of the housing piece 12 into the input device 152 as indicated by block 156. The length could be in standard length measurement units, such as millimeters, or in non-standard length measurement units, such as the number of contact receiving apertures 14 in the housing piece 12 or a model number for the housing piece; the controller 24 having a memory 25 of recorded lengths for the model numbers. The user then inputs 158 the desired cut housing piece lengths. Similar to step 156, this could be standard or non-standard or computer memory assisted lengths.

The controller 24 is now able to determine 160 the lengths of all the pieces intended to be cut off the housing piece 12 (both for a scrap cut housing piece and desired length cut housing pieces) in order to maximize the number of desired length cut housing pieces to be produced with the minimal amount of waste. Referring also to FIG. 10 an example of this will be described. In this example the housing piece 12 has an uncut length L. The user inputs the desired cut housing length X₂. The controller 24 then determines that N desired length cut housing pieces 12′ can be formed, where N is a whole number. The controller 24 also determines the length of scrap cut housing piece 12″; i.e.: a piece which will have a length X₁ which is less than length X₂. A scrap piece 12″ could be a front piece, a middle piece or a rear piece. The controller 24 determines the locations for the cuts 108 to produce the maximum number N of cut pieces 12′. As an example, when the units of length being used are based upon the number of apertures 14, if the housing piece 12 has fifty apertures in a row, and housing pieces 12′ are desired to have a length of fifteen apertures, and taking into consideration that an aperture length will be lost at each cut 108, then three housing pieces X₂ can be formed with the desired length of fifteen apertures each, a scrap piece 12″ will be formed with a length X₁ of two apertures 14, and three aperture lengths will be lost to cuts 108 (L=(N·X₂)−(N)−X₁; i.e.: 50=(3×15)+3−2). If there is no scrap piece, then L=(N·X₂)−(N−1). The length of the scrap piece can be found using the following formula: X₁=L−(Rounddown (L÷N)) where Rounddown (L÷N) is the value of L÷N rounded down to a whole number. Stated another way, X₁=L−(X₂·N). In a preferred embodiment the scrap piece 12″ is cut off of the original piece 12 first, but scrap piece(s) can be cut off anywhere and, more than two lengths (X₁, X₂) can be cut off of the original piece 12.

Referring back to FIG. 9, after the controller 24 determines 160 how to cut the original housing piece 12 to produce the desired results, the controller 24 moves the diverter 22, as indicated by block 162, to an appropriate position for the upcoming piece about to be cut off. In this embodiment scrap pieces 12″ are passed into the drawer 32 and desired length pieces 12′ are passed into the drawer 30. If the next piece to be cut off is a scrap piece 12″, then the drive 128 is actuated to move the top 144 of the plate section 124 forward such that the rear surface 142 can guide the cut scrap piece into the hole 40. If the next piece to be cut off is a desired length piece 12′, then the drive 128 is actuated to move the top 144 to a rearward position such that the front surface 140 can guide the cut piece 12′ into the hole 38.

After the diverter is moved, the mover 20 moves 162 the housing piece 12 in direction B until the first area 108 is located at the cutting area 68. The clamp 88 is actuated to clamp the housing piece in place at the cutting area 68. Then the motor 44 and drive 74 are actuated to cut 166 a piece off of the housing piece 12.

After the cut 166, the clamp 88 is lifted to an up position, the cut piece falls into one of the drawers 30, 32 (based upon the position of the diverter), and the cutting wheel 46 is retracted back out of the path of the housing piece 12 in the guide 36. The controller 24 can then move 168 the diverter 22 based upon what type of piece (scrap or desired length) is going to be cut off next. The mover 20 then move 170 the housing piece 12 along the guide 36 again to position the housing piece 12 for the next clamping and then cut 172. If all pieces have been cut, as determined at block 174, then the method returns to start 154 for loading of a new uncut housing piece 12. If all pieces are not cut, then the method returns to block 170. The method described with reference to FIG. 9 is only one simplified method. The method could clearly be modified or adapted, but still produce the same results.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. An electrical connector housing cutting apparatus comprising:
a guide for slidably supporting an electrical connector housing along a linear movement path; and
a rotating cutting member movable into and out of the movement path, the cutting member having an axis of rotation generally parallel to a direction of movement of the electrical connector housing along the movement path.

2. A cutting apparatus as in claim 1 further comprising a mover for moving the electrical connector housing along the path.

3. A cutting apparatus as in claim 2 further comprising a controller connected to the mover for controlling movement of the mover to move the housing predetermined lengths of movement along the movement path.

4. A cutting apparatus as in claim 2 wherein the mover comprises a projection which extends into a contact receiving aperture of the housing.

5. A cutting apparatus as in claim 1 wherein the rotating cutting member is mounted on a slidable mount, the slidable mount being movable in directions generally perpendicular to the direction of movement of the housing along the movement path.

6. A cutting apparatus as in claim 5 further comprising a motor connected to the rotating cutting member by a variable length transmission, wherein a distance between the motor and the cutting member can be varied.

7. A cutting apparatus as in claim 1 further comprising a movably clamp for clamping the electrical connector housing in the guide, wherein the clamp comprises at least one projection adapted to be inserted into a contact receiving aperture of the electrical connector housing.

8. A cutting apparatus as in claim 7 wherein the clamp comprises a slot opposite the rotating cutting member adapted to receive a portion of the rotating cutting member in the slot.

9. A cutting apparatus as in claim 1 further comprising a movable diverter in the movement path at a location past the rotating cutting member, the diverter being movable between at least two positions.

10. A cutting apparatus as in claim 9 further comprising a computer controller connected to the diverter and a mover for moving the electrical connector housing along the movement path of the guide, wherein the controller is adapted to move the mover based upon a length of a housing piece being cut from the electrical connector housing.

11. An electrical connector housing cutting apparatus comprising:
a cutter for cutting an electrical connector housing into multiple pieces;
a mover for moving the electrical connector housing relative to the cutter;
a diverter, located after the cutter in a path of the electrical connector, movable between at least two positions for allowing a cut one of the pieces to move to one of at least two predetermined locations; and
a computer controller connected to the mover and the diverter for moving the diverter based, at least partially, upon a next intended length of movement of the electrical connector housing by the mover.

12. A cutting apparatus as in claim 11 wherein the cutter comprises a rotating cutting wheel having an axis of rotation generally parallel to a path of movement of the electrical connector housing to the cutting wheel.

13. A cutting apparatus as claim 12 wherein the apparatus further comprises a frame, and wherein the cutter further comprises a linear movable mount connected between the frame of the apparatus and the rotating cutting wheel, wherein the movable mount allows the rotating cutting wheel to move into and out of the path of movement of the electrical connector housing.

14. A cutting apparatus as in claim 13 wherein the cutter further comprises a motor connected to the frame at a stationary location and a variable distance transmission between the motor and the rotating cutting wheel such that a distance between the motor and the cutting wheel can be varied.

15. A cutting apparatus as in claim 11 wherein the diverter comprises a plate section with housing piece contact surfaces on opposite sides of the plate section, and wherein the plate section is pivotably mounted to a frame of the apparatus.

16. A cutting apparatus as in claim 11 wherein the computer controller is adapted to calculate a length of a undesired length scrap housing piece to be diverted by the diverter to a first one of the predetermined locations, and adapted to calculate a number of desired length housing pieces to be diverted by the diverter to a second one of the predetermined locations, based upon a length of the electrical connector housing and a desired length of the desired length housing pieces.

17. A cutting apparatus as in claim 11 further comprising a movable clamp located at a cutting location of the cutter, the clamp comprising a projection movable into a contact receiving aperture of the electrical connector housing.

18. A cutting apparatus as in claim 11 further comprising a movable clamp located at a cutting location of the cutter, the clamp comprising a slot for a cutting wheel of the cutter to rotate through, the clamp comprising projections which are movable into and out of the path.

19. A method of cutting an electrical connector housing into multiple pieces comprising steps of:
moving the housing along a housing movement path to a cutting position;
moving a rotating cutting wheel across the movement path at the cutting position, the wheel rotating in an axis of rotation generally parallel to the movement path; and
automatically separating an undesired length cut housing piece from desired length cut housing pieces as the pieces move away from the cutting position.

20. A method as in claim 19 wherein the step of moving comprises positioning a projection into a contact receiving aperture of the electrical connector housing and pushing the housing towards the cutting position by the projection in the aperture.

21. A method as in claim 19 further comprising clamping the electrical connector housing at the cutting position, the step of clamping comprising locating projections into contact receiving apertures of the electrical connector housing on opposite sides of the cutting position.

22. A method as in claim 19 wherein the step of moving the housing comprising locating a contact receiving aperture of the housing at the cutting position, wherein the cutting wheel cuts through the contact receiving aperture.

23. A method as in claim 19 further comprising determining a length of the undesired length cut housing piece based upon:
X₁=L−(Rounddown(L÷N))
where N is a number of desired length cut housing pieces to be formed,
L is a length of the electrical connector housing,
X₁ is the length of the undesired length cut housing piece, and
Rounddown L÷N is a rounded down value of L÷N to a whole number.

24. A method as in claim 19 further comprising determining a length of the undesired length cut housing piece based upon;
X₁=L−(X₂·N)
where X₁ is the length of the undesired length cut housing piece,
L is a length of the electrical connector housing,
X₂ is a desired length of the desired length cut housing pieces, and
N is a whole number of desired length housing pieces which can be formed from the length L with the desired length X₂.

25. A method of cutting an electrical receptacle connector housing, comprising the steps of:
providing an electrical receptacle connector housing, said housing having apertures for receiving contacts therein; and
cutting said housing through at least one of said apertures.
